(19) United States
(12) Patent Application Publication
(10) Pub. No.: US 2006/0090634 A1
(43) Pub. Date: May 4, 2006

(54) Apparatus and method for adjusting a digital setting value at a variable speed

(75) Inventors: Meng-Wen Pan, Hsinchu City (TW); Chi-Sung Tsai, Hsinchu City (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/260,123

(22) Filed: Oct. 28, 2005

(30) Foreign Application Priority Data
Oct. 29, 2004 (TW) 093132979

(51) Int. Cl. G10H 3/00; G10H 1/32

(52) U.S. Cl. 84/743

(57) ABSTRACT

An apparatus for adjusting a digital setting value at a variable speed includes an up key and a down key for generating a plurality of up and down pulses, an input/output interface connected to the up key and the down key, a processor connected to the input/output interface, and a display. The processor, in which a default digital setting value is stored, receives the up pulses and the down pulses through the input/output interface. The processor adds an adjustment value to or subtracts the adjustment value from the default digital setting value according to a time interval between adjacent two of the up pulses or adjacent two of the down pulses so as to obtain a digital output value to be outputted to the display, which displays the digital output value. The adjustment value increases as the time interval decreases.

### BACKGROUND OF THE INVENTION

1. Field of the Invention

The invention relates to an apparatus and a method of adjusting a digital setting value at a variable speed, and more particularly to an apparatus and a method of adjusting a digital setting value at a variable speed according to a mode of actuating a key.

2. Description of the Related Art

In a conventional digital product, the user can input a digital value through a keypad or an up key and a down key. For example, the method of inputting the time in an electronic watch and the method of adjusting a scaling ratio in a copier are performed using the up key and the down key. When the up key is pressed or actuated, the value displayed on the display is increased by 1. If the user continuously presses the up key for a period of time, the value displayed on the display increases at a predetermined speed, increases by an increment of 1. If the predetermined speed is too low, the user may feel that it is more convenient to press and release the key repeatedly. If the predetermined speed is too high, the user cannot precisely catch the desired value. Thus, the user has to spend a longer time to adjust this value, and the efficiency is poor.

To solve this problem, U.S. Pat. No. 4,763,174 discloses a magnification selection apparatus for a copier, wherein the apparatus adopts the method mentioned hereinabove but automatically slows down the speed of variation of the magnification as the varying magnification approximates several predetermined magnifications. If the default magnifications are 90%, 80%, 70% and 60% and the user wants to adjust the magnification of 100% to the magnification of 60%, then the user has to encounter three time periods in which the magnification decreases slowly. Thus, it is also inconvenient because the time of adjustment lengthens.

In addition, it is possible that some users do not know such a function of adjusting the value by continuously pressing the key. Furthermore, the key being continuously pressed tends to fatigue and thus shorten the lifetime thereof or influence the subsequent usage. Moreover, because the processor of the digital product has to detect whether the key has been pressed for a predetermined period of time and then enables the function of continuously increasing or decreasing, the firmware design for this adjusting method is more complicated.

### SUMMARY OF THE INVENTION

It is therefore an object of the invention to provide an apparatus and a method of adjusting a digital setting value at a variable speed according to a mode of actuating a key.

To achieve the above-identified objet, the invention provides an apparatus for adjusting a digital setting value at a variable speed. The apparatus includes an up key, a down key, an input/output interface, a processor and a display. The up key generates a plurality of up pulses after being actuated multiple times. The down key generates a plurality of down pulses after being actuated multiple times. The input/output interface is connected to the up key and the down key. The processor is connected to the input/output interface. The processor, in which a default digital setting value is stored, receives the up pulses and the down pulses through the input/output interface, and adds an adjustment value to or subtracts the adjustment value from the default digital setting value according to a time interval between adjacent two of the up pulses or adjacent two of the down pulses so as to obtain a digital output value. The adjustment value increases as the time interval decreases. The display receives and displays the digital output value.

The invention also provides a method for adjusting a digital setting value at a variable speed. The method includes the steps of: receiving a plurality of up pulses or a plurality of down pulses; calculating a time interval between adjacent two of the up pulses or adjacent two of the down pulses; adding an adjustment value to or subtracting the adjustment value from a default digital setting value to obtain a digital output value, wherein the adjustment value increases as the time interval decreases; and displaying the digital output value.

According to the apparatus and method of the invention, the speed of adjusting may be controlled according to the frequency of actuating the key using the simple firmware, and the time of obtaining the desired digital output value may be shortened.

### BRIEF DESCRIPTION OF THE DRAWINGS

FIG. 1 is a schematic illustration showing an apparatus of adjusting a digital setting value at a variable speed according to a preferred embodiment of the invention.

FIG. 2 is a flow chart showing a method for adjusting a digital setting value at a variable speed according to the preferred embodiment of the invention.

### DETAILED DESCRIPTION OF THE INVENTION

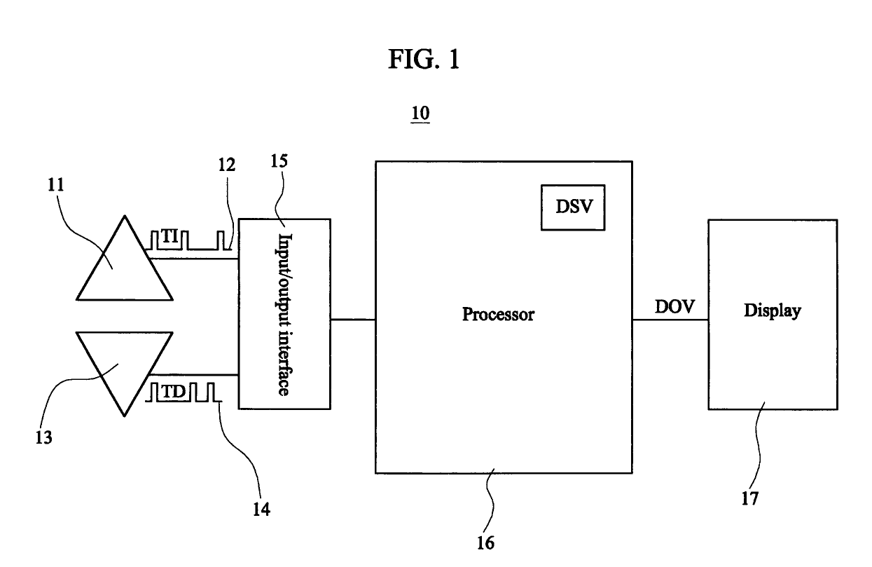

FIG. 1 is a schematic illustration showing an apparatus of adjusting a digital setting value at a variable speed according to a preferred embodiment of the invention. Referring to FIG. 1, the apparatus 10 of this embodiment includes an up key 11, a down key 13, an input/output interface 15, a processor 16 and a display 17.

The up key 11 generates a plurality of up pulses 12 after being actuated multiple times. The down key 13 generates a plurality of down pulses 14 after being actuated multiple times. The input/output interface 15 is connected to the up key 11 and the down key 13. The processor 16 connected to the input/output interface 15 receives the up pulses 12 and the down pulses 14 through the input/output interface 15. The processor 16, in which a default digital setting value DSV is stored, adds an adjustment value to or subtracts the adjustment value from the default digital setting value DSV according to a time interval TI/TD between adjacent two of the up pulses 12 or adjacent two of the down pulses 14 so as to obtain a digital output value DOV. The adjustment value may increase continuously or discontinuously as the time interval TI/TD decreases continuously. When no time interval TI/TD is detected, the processor 16 adds a basic value to or subtracts the basic value from the default digital setting value DSV. Then, the display 17 receives and displays the digital output value DOV.

Illustration will be made by taking the operation of adjusting the scaling ratio as an example. In this example, the default digital setting value DSV is 100%, the basic value is 1%. When the up key 11 is actuated at the first time, the time interval TI cannot be obtained, so the digital output value DOV is 101%. Next, if the up key 11 is actuated at the second time after 1 second, the time interval TI is 1 second. If the adjustment value corresponding to the time interval TI of 1 second is 1, the digital output value DOV is 102%. Then, the up key 11 is actuated at the second time after 0.9 seconds, the time interval TI is 0.9 seconds, and the adjustment value corresponding to the time interval TI of 0.9 seconds is 2%. In a similar manner, the adjustment values corresponding the time intervals of 0.8, 0.7, 0.6 and 0.5 seconds are 3%, 4%, 5% and 6%, respectively. Thus, as the key is actuated more frequently, the adjustment value gets larger. When the desired scaling ratio is to be reached, the key will be actuated less frequently, and the adjustment value will get smaller such that the desired scaling ratio may be easily made.

The time interval may continuously vary with the continuous variation of the adjustment value in a manner like an arithmetic sequence or a common ratio sequence.

Alternatively, the time interval may vary discontinuously with the continuous variation of the adjustment value. For example, the adjustment value corresponding to the time interval ranging from 0.75 to 0.6 seconds is configured to be 5%, and the adjustment value corresponding to the time interval ranging from 0.6 to 0.5 seconds is 10%.

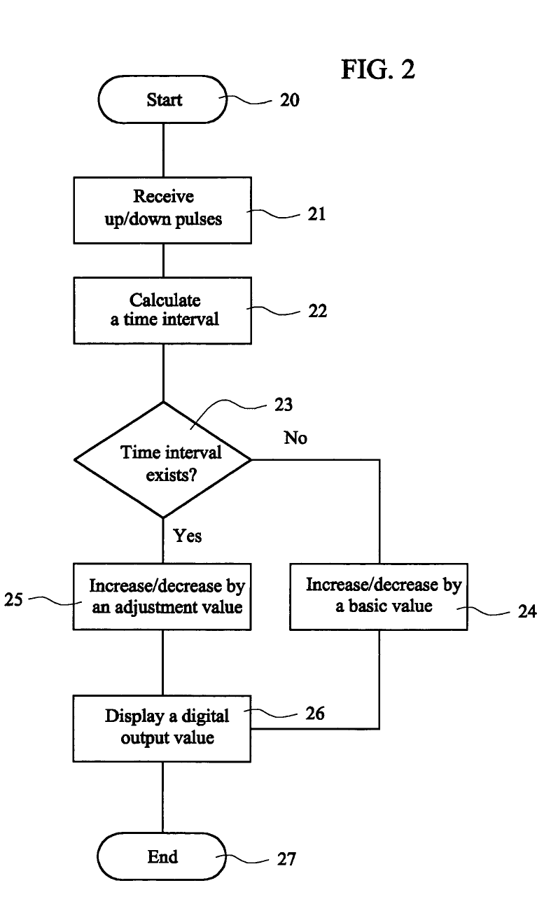

FIG. 2 is a flow chart showing a method for adjusting a digital setting value at a variable speed according to the preferred embodiment of the invention. The method includes the following steps.

Step 20 starts the procedure.

Step 21 receives a plurality of up pulses or a plurality of down pulses.

Step 22 calculates a time interval between two adjacent up pulses or down pulses.

Step 23 judges whether the time interval exists or not. If not, the procedure goes to step 24; or otherwise the procedure goes to step 25.

Step 24 adds a basic value to or subtracts the basic value from a default digital setting value so as to obtain a digital output value when the time interval does not exist or when the up/down key is actuated discontinuously (e.g., first actuation of the key, switching from the up key to the down key, or switching from the down key to the up key). Then, the procedure goes to step 26.

Step 25 adds an adjustment value to or subtracts the adjustment value from the default digital setting value so as to obtain a digital output value. The adjustment value may increase continuously or discontinuously as the time interval decreases continuously.

Step 26 displays the digital output value.

Step 27 ends the procedure.

According to the apparatus and method of the invention, the speed of adjusting may be controlled according to the frequency of actuating the key using the simple firmware, and the time of obtaining the desired digital output value may be shortened. In addition, the key is pressed discontinuously and is thus free from the fatigue, which frequently occurs because the key is continuously pressed for a period of time.

While the invention has been described by way of example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. An apparatus for adjusting a digital setting value at a variable speed, the apparatus comprising:
an up key for generating a plurality of up pulses after being actuated multiple times;
a down key for generating a plurality of down pulses after being actuated multiple times;
an input/output interface connected to the up key and the down key;
a processor connected to the input/output interface, wherein the processor, in which a default digital setting value is stored, receives the up pulses and the down pulses through the input/output interface, and adds an adjustment value to or subtracts the adjustment value from the default digital setting value according to a time interval between adjacent two of the up pulses or adjacent two of the down pulses so as to obtain a digital output value, and the adjustment value increases as the time interval decreases; and
a display for receiving and displaying the digital output value.

2. The apparatus according to claim 1, wherein the adjustment value continuously increases as the time interval decreases continuously.

3. The apparatus according to claim 1, wherein the adjustment value discontinuously increases as the time interval decreases continuously.

4. The apparatus according to claim 1, wherein the processor adds a basic value to or subtracts the basic value from the default digital setting value so as to obtain the digital output value when the processor cannot detect the time interval.

5. A method for adjusting a digital setting value at a variable speed, comprising the steps of:
receiving a plurality of up pulses or a plurality of down pulses;
calculating a time interval between adjacent two of the up pulses or adjacent two of the down pulses;
adding an adjustment value to or subtracting the adjustment value from a default digital setting value to obtain a digital output value, wherein the adjustment value increases as the time interval decreases; and
displaying the digital output value.

6. The method according to claim 5, wherein the adjustment value continuously increases as the time interval decreases continuously.

7. The method according to claim 5, wherein the adjustment value discontinuously increases as the time interval decreases continuously.

8. The method according to claim 5, further comprising the step of:
adding a basic value to or subtracting the basic value from the default digital setting value to obtain the digital output value when no time interval is detected.
